(19) United States
(12) Patent Application Publication
(10) Pub. No.: US 2017/0300193 A1
(43) Pub. Date: Oct. 19, 2017

(54) BUILDING MANAGEMENT SYSTEM USER INTERFACES

(71) Applicant: Johnson Controls Technology Company, Plymouth, MI (US)

(72) Inventors: Beth A. Ray, Oak Creek, WI (US); Sheri L. Meyer, Wauwatosa, WI (US); Gouri M. Dimino, Wauwatosa, WI (US)

(73) Assignee: Johnson Controls Technology Company, Plymouth, MI (US)

(21) Appl. No.: 15/489,573

(22) Filed: Apr. 17, 2017

Related U.S. Application Data
(60) Provisional application No. 62/324,213, filed on Apr. 18, 2016.

(51) Int. Cl. G06F 3/0482; H04L 12/24; G06F 3/0484

(52) U.S. Cl. CPC G06F 3/0482; G06F 3/04847; H04L 41/22

(57) ABSTRACT

A building management system includes a processing circuit coupled to a building network. The building network includes at least one server, at least one supervisory engine, at least one field controller, and at least one edge device. The processing circuit is configured to provide a graphical user interface including a building network riser diagram of the building network. The building network riser diagram has at least two of (i) a server section configured to display a first graphical representation of the at least one server, (ii) an engine section configured to display a second graphical representation of the at least one supervisory engine, (iii) a field controller section configured to display a third graphical representation of the at least one field controller, and (iv) an edge device section configured to display a fourth graphical representation of the at least one edge device.

### CROSS-REFERENCE TO RELATED PATENT APPLICATIONS

This application claims the benefit of U.S. Provisional Patent Application No. 62/324,213, filed Apr. 18, 2016, which is incorporated herein by reference in its entirety.

### BACKGROUND

The present disclosure relates generally to the field of building management systems. A building management system (BMS) is, in general, a system of devices configured to control, monitor, and manage equipment in or around a building or building area. A BMS can include, for example, an HVAC system, a security system, a lighting system, a fire alerting system, any other system that is capable of managing building functions or devices, or any combination thereof.

### SUMMARY

One implementation of the present disclosure is a building management system (BMS). The BMS includes a processing circuit coupled to a building network. The building network includes at least one server, at least one supervisory engine, at least one field controller, and at least one edge device. The processing circuit is configured to provide a graphical user interface including a building network riser diagram of the building network. The building network riser diagram has at least two of (i) a server section configured to display a first graphical representation of the at least one server, (ii) an engine section configured to display a second graphical representation of the at least one supervisory engine, (iii) a field controller section configured to display a third graphical representation of the at least one field controller, and (iv) an edge device section configured to display a fourth graphical representation of the at least one edge device.

Another implementation of the present disclosure is a building management system (BMS). The BMS includes a processing circuit coupled to a building network. The building network has a plurality of points. The processing circuit is configured to provide a graphical user interface. The graphical user interface includes (i) current priorities for a selected point of the plurality of points, (ii) potential impacts for the selected point of the plurality of points, and (iii) a priority array that orders the current priorities from a highest priority level to a lowest priority level.

Another implementation of the present disclosure is a building management system (BMS). The BMS includes a processing circuit coupled to a building network. The building network has a plurality of points. The processing circuit is configured to provide a graphical user interface. The graphical user interface includes (i) at least one of trend information and audit information regarding a selected point of the plurality of points, (ii) current priorities for the selected point of the plurality of points, (ii) and potential impacts for the selected point of the plurality of points.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

FIG. 1 is a drawing of a building equipped with a building management system (BMS) and a HVAC system, according to some embodiments.

FIG. 2 is a schematic of a waterside system which can be used as part of the HVAC system of FIG. 1, according to some embodiments.

FIG. 3 is a block diagram of an airside system which can be used as part of the HVAC system of FIG. 1, according to some embodiments.

FIG. 4 is a block diagram of a BMS which can be used in the building of FIG. 1, according to some embodiments.

FIG. 5 is a block diagram of various graphical user interfaces (GUIs) of the BMS of FIG. 4, according to some embodiments.

FIG. 6A is an illustration of a building network riser GUI of the BMS of FIG. 4, according to some embodiments.

FIG. 6B is an illustration of a building network riser GUI of the BMS of FIG. 4, according to some embodiments.

FIG. 6C is a method of filtering a building network riser diagram of the BMS of FIG. 4, according to some embodiments.

FIG. 7 is an illustration of an equipment relationships GUI of the BMS of FIG. 4, according to some embodiments.

FIGS. 8A and 8B are illustrations of an equipment summary GUI of the BMS of FIG. 4, according to some embodiments.

FIGS. 9A-9C are illustrations of a building navigation GUI of the BMS of FIG. 4, according to some embodiments.

FIGS. 10A-10F are illustrations of an item information GUI of the BMS of FIG. 4, according to some embodiments.

FIG. 11 is an illustration of a live logic GUI of the BMS of FIG. 4, according to some embodiments.

FIG. 12 is an illustration of a system view GUI of the BMS of FIG. 4, according to some embodiments.

FIGS. 13-16 are various graphical flow diagrams of navigating through GUIs of a BMS, according to various example embodiments.

### DETAILED DESCRIPTION

### Building Management System and HVAC System

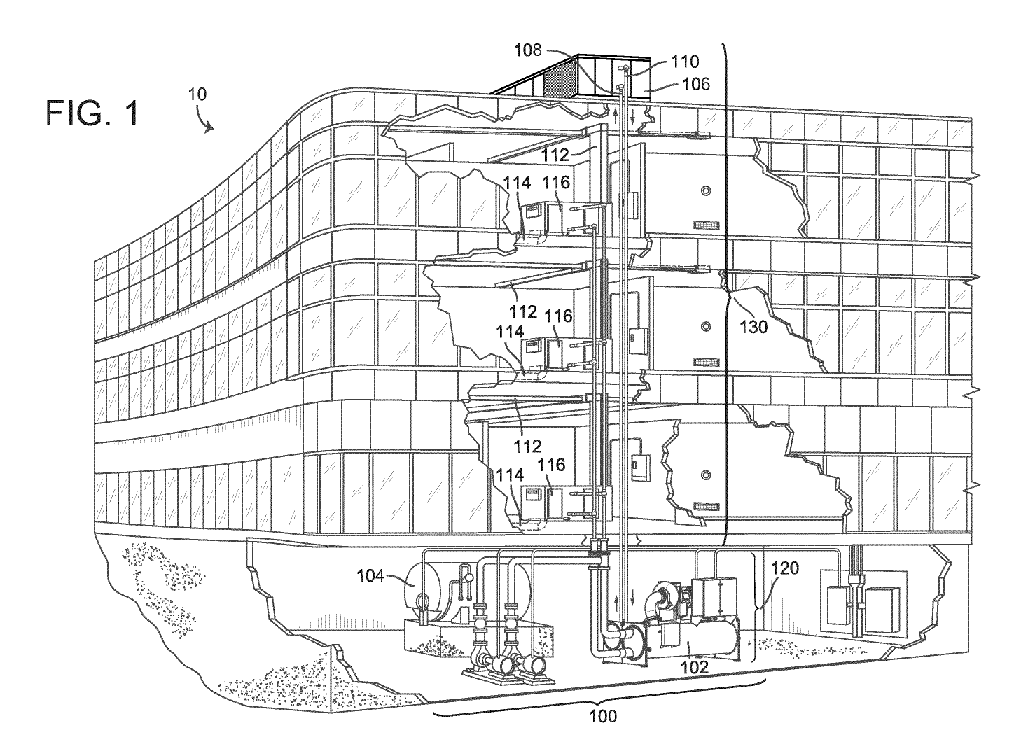

Referring now to FIGS. 1-4, an example building management system (BMS) and HVAC system in which the systems and methods of the present disclosure can be implemented are shown, according to an example embodiment. Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

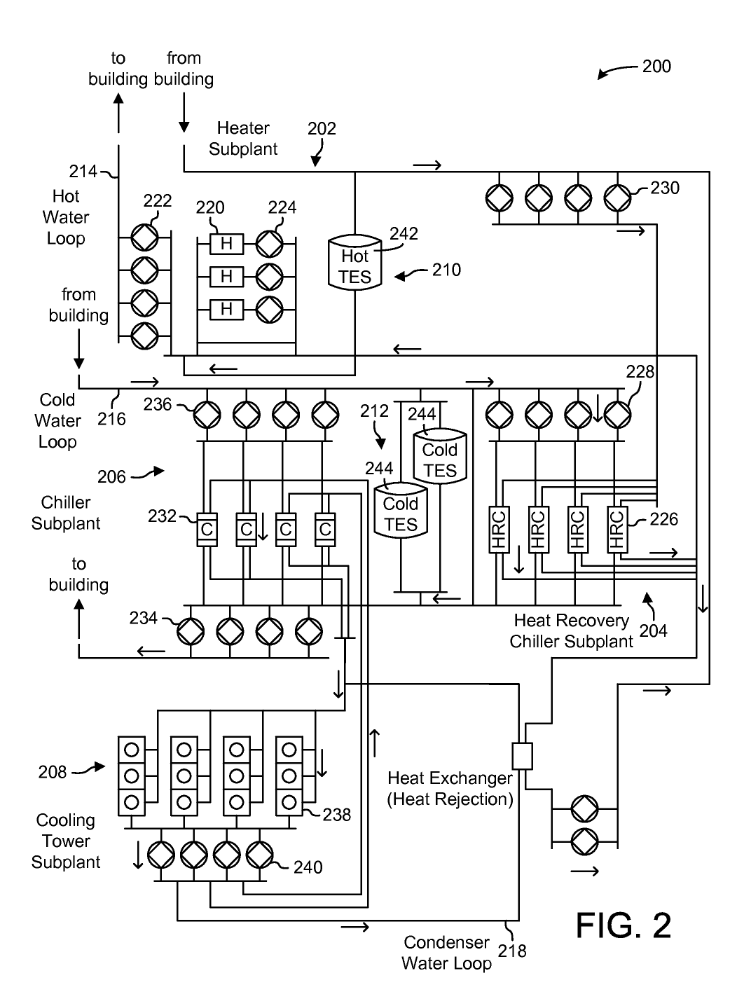

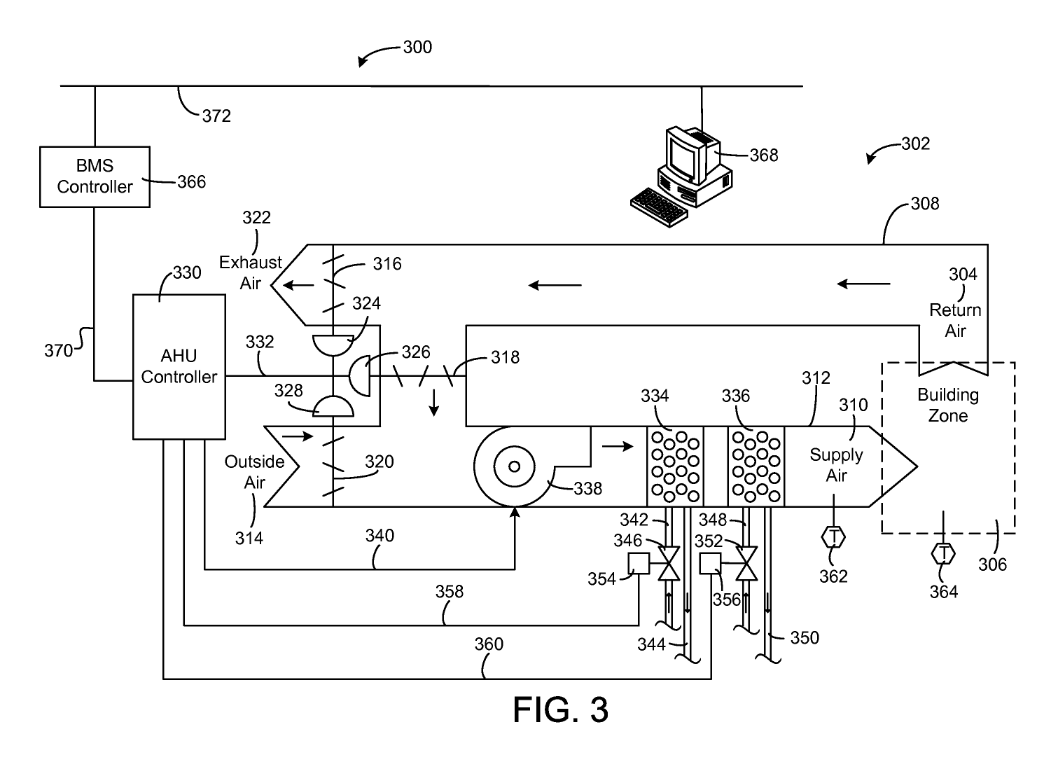

The BMS that serves building 10 includes an HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 can provide a heated or chilled fluid to an air handling unit of airside system 130. Airside system 130 can use the heated or chilled fluid to heat or cool an airflow provided to building 10. An example waterside system and airside system which can be used in HVAC system 100 are described in greater detail with reference to FIGS. 2 and 3.

HVAC system 100 is shown to include a chiller 102, a boiler 104, and a rooftop air handling unit (AHU) 106. Waterside system 120 can use boiler 104 and chiller 102 to heat or cool a working fluid (e.g., water, glycol, etc.) and can circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 can add heat to the circulated fluid, for example, by burning a combustible material (e.g., natural gas) or using an electric heating element. Chiller 102 can place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 can place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 can transfer heat between the airflow and the working fluid to provide heating or cooling for the airflow. For example, AHU 106 can include one or more fans or blowers configured to pass the airflow over or through a heat exchanger containing the working fluid. The working fluid can then return to chiller 102 or boiler 104 via piping 110.

Airside system 130 can deliver the airflow supplied by AHU 106 (i.e., the supply airflow) to building 10 via air supply ducts 112 and can provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 can receive input from sensors located within AHU 106 and/or within the building zone and can adjust the flow rate, temperature, or other attributes of the supply airflow through AHU 106 to achieve setpoint conditions for the building zone.

Referring now to FIG. 2, a block diagram of a waterside system 200 is shown, according to an example embodiment. In various embodiments, waterside system 200 can supplement or replace waterside system 120 in HVAC system 100 or can be implemented separate from HVAC system 100. When implemented in HVAC system 100, waterside system 200 can include a subset of the HVAC devices in HVAC system 100 (e.g., boiler 104, chiller 102, pumps, valves, etc.) and can operate to supply a heated or chilled fluid to AHU 106. The HVAC devices of waterside system 200 can be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve the thermal energy loads (e.g., hot water, cold water, heating, cooling, etc.) of a building or campus. For example, heater subplant 202 can be configured to heat water in a hot water loop 214 that circulates the hot water between heater subplant 202 and building 10. Chiller subplant 206 can be configured to chill water in a cold water loop 216 that circulates the cold water between chiller subplant 206 building 10. Heat recovery chiller subplant 204 can be configured to transfer heat from cold water loop 216 to hot water loop 214 to provide additional heating for the hot water and additional cooling for the cold water. Condenser water loop 218 can absorb heat from the cold water in chiller subplant 206 and reject the absorbed heat in cooling tower subplant 208 or transfer the absorbed heat to hot water loop 214. Hot TES subplant 210 and cold TES subplant 212 can store hot and cold thermal energy, respectively, for subsequent use.

Hot water loop 214 and cold water loop 216 can deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air can be delivered to individual zones of building 10 to serve the thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) can be used in place of or in addition to water to serve the thermal energy loads. In other embodiments, subplants 202-212 can provide heating and/or cooling directly to the building or campus without requiring an intermediate heat transfer fluid. These and other variations to waterside system 200 are within the teachings of the present invention.

Each of subplants 202-212 can include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 can also include one or more pumps or valves configured to control the flow rate of the hot water into or out of hot TES tank 242. Cold TES subplant 212 is shown to include cold TES tanks 244 configured to store the cold water for later use. Cold TES subplant 212 can also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves can be integrated with the pumps or positioned upstream or downstream of the pumps to control the fluid flows in waterside system 200. In various embodiments, waterside system 200 can include more, fewer, or different types of devices and/or subplants based on the particular configuration of waterside system 200 and the types of loads served by waterside system 200.

Referring now to FIG. 3, a block diagram of an airside system 300 is shown, according to an example embodiment. In various embodiments, airside system 300 can supplement or replace airside system 130 in HVAC system 100 or can be implemented separate from HVAC system 100. When implemented in HVAC system 100, airside system 300 can include a subset of the HVAC devices in HVAC system 100 (e.g., AHU 106, VAV units 116, duct 112, duct 114, fans, dampers, etc.) and can be located in or around building 10. Airside system 300 can operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 can receive return air 304 from building zone 306 via return air duct 308 and can deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 can be configured to operate exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 can communicate with an AHU controller 330 via a communications link 332. Actuators 324-328 can receive control signals from AHU controller 330 and can provide feedback signals to AHU controller 330. Feedback signals can include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 can communicate with fan 338 via communications link 340 to control a flow rate of supply air 310. In some embodiments, AHU controller 330 controls an amount of heating or cooling applied to supply air 310 by modulating a speed of fan 338.

Cooling coil 334 can receive a chilled fluid from waterside system 200 (e.g., from cold water loop 216) via piping 342 and can return the chilled fluid to waterside system 200 via piping 344. Valve 346 can be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 can receive a heated fluid from waterside system 200 (e.g., from hot water loop 214) via piping 348 and can return the heated fluid to waterside system 200 via piping 350. Valve 352 can be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 can communicate with AHU controller 330 via communications links 358-360. Actuators 354-356 can receive control signals from AHU controller 330 and can provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 can also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU controller 330 can control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller 366 and a client device 368. BMS controller 366 can include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 can communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 can be separate (as shown in FIG. 3) or integrated. In an integrated implementation, AHU controller 330 can be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 can provide BMS controller 366 with temperature measurements from temperature sensors 362 and 364, equipment on/off states, equipment operating capacities, and/or any other information that can be used by BMS controller 366 to monitor or control a variable state or condition within building zone 306.

Client device 368 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 can be a computer workstation, a client terminal, a remote or local interface, or any other type of user interface device. Client device 368 can be a stationary terminal or a mobile device. For example, client device 368 can be a desktop computer, a computer server with a user interface, a laptop computer, a tablet, a smartphone, a PDA, or any other type of mobile or non-mobile device. Client device 368 can communicate with BMS controller 366 and/or AHU controller 330 via communications link 372.

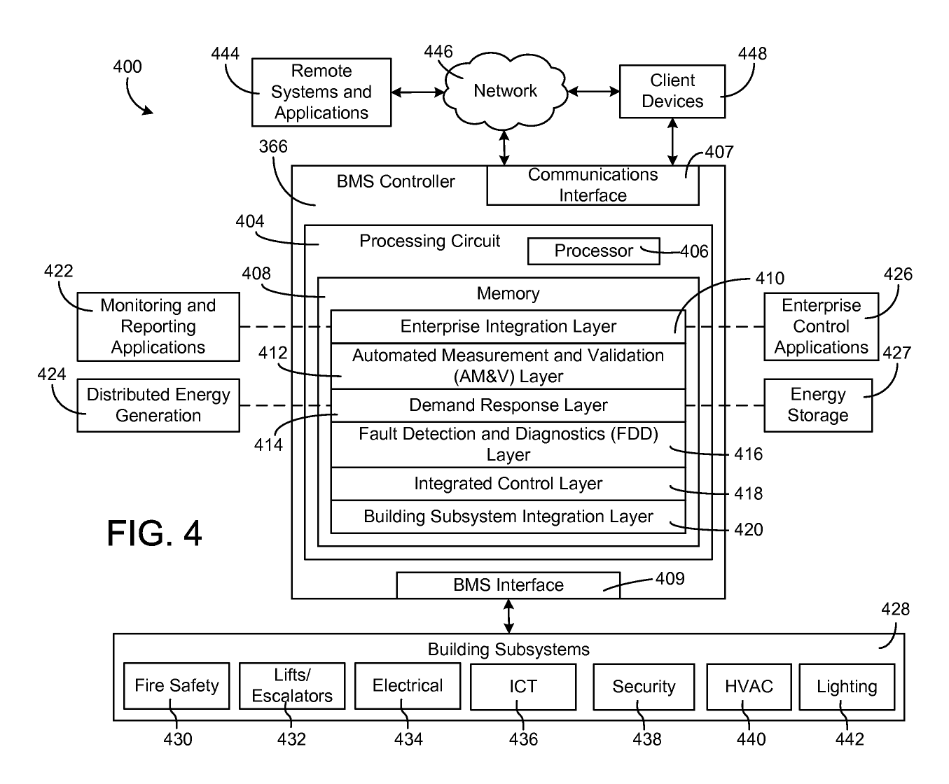

Referring now to FIG. 4, a block diagram of a building management system (BMS) 400 is shown, according to an example embodiment. BMS 400 can be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 can also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2 and 3.

Each of building subsystems 428 can include any number of devices, controllers, and connections for completing its individual functions and control activities. HVAC subsystem 440 can include many of the same components as HVAC system 100, as described with reference to FIGS. 1-3. For example, HVAC subsystem 440 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 can include any number of light fixtures, ballasts, lighting sensors, dimmers, or other devices configured to controllably adjust the amount of light provided to a building space. Security subsystem 438 can include occupancy sensors, video surveillance cameras, digital video recorders, video processing servers, intrusion detection devices, access control devices (e.g., card access, etc.) and servers, or other security-related devices.

Still referring to FIG. 4, BMS controller 366 is shown to include a communications interface 407 and a BMS interface 409. Interface 407 can facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 can also facilitate communications between BMS controller 366 and client devices 448. BMS interface 409 can facilitate communications between BMS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 can be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a Wi-Fi transceiver for communicating via a wireless communications network. In another example, one or both of interfaces 407, 409 can include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 can be communicably connected to BMS interface 409 and/or communications interface 407 such that processing circuit 404 and the various components thereof can send and receive data via interfaces 407, 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 408 can be or include volatile memory or non-volatile memory. Memory 408 can include database components, object code components, script components, or any other type of information structure for supporting the various activities and information structures described in the present application. According to an example embodiment, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments BMS controller 366 can be distributed across multiple servers or computers (e.g., that can exist in distributed locations). Further, while FIG. 4 shows applications 422 and 426 as existing outside of BMS controller 366, in some embodiments, applications 422 and 426 can be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 can also or alternatively be configured to provide configuration GUIs for configuring BMS controller 366. In yet other embodiments, enterprise control applications 426 can work with layers 410-420 to optimize building performance (e.g., efficiency, energy use, comfort, or safety) based on inputs received at interface 407 and/or BMS interface 409.

Building subsystem integration layer 420 can be configured to manage communications between BMS controller 366 and building subsystems 428. For example, building subsystem integration layer 420 can receive sensor data and input signals from building subsystems 428 and provide output data and control signals to building subsystems 428. Building subsystem integration layer 420 can also be configured to manage communications between building subsystems 428. Building subsystem integration layer 420 translate communications (e.g., sensor data, input signals, output signals, etc.) across a plurality of multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 can receive inputs from other layers of BMS controller 366 (e.g., building subsystem integration layer 420, integrated control layer 418, etc.). The inputs received from other layers can include environmental or sensor inputs such as temperature, carbon dioxide levels, relative humidity levels, air quality sensor outputs, occupancy sensor outputs, room schedules, and the like. The inputs can also include inputs such as electrical use (e.g., expressed in kWh), thermal load measurements, pricing information, projected pricing, smoothed pricing, curtailment signals from utilities, and the like.

According to an example embodiment, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 can also include control logic configured to determine when to utilize stored energy. For example, demand response layer 414 can determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models can represent collections of building equipment (e.g., subplants, chiller arrays, etc.) or individual devices (e.g., individual chillers, heaters, pumps, etc.).

Demand response layer 414 can further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In an example embodiment, integrated control layer 418 includes control logic that uses inputs and outputs from a plurality of building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints can also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 can compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 can receive data inputs from integrated control layer 418, directly from one or more building subsystems or devices, or from another data source. FDD layer 416 can automatically diagnose and respond to detected faults. The responses to detected or diagnosed faults can include providing an alert message to a user, a maintenance scheduling system, or a control algorithm configured to attempt to repair the fault or to work-around the fault.

FDD layer 416 can be configured to output a specific identification of the faulty component or cause of the fault (e.g., loose damper linkage) using detailed subsystem inputs available at building subsystem integration layer 420. In other example embodiments, FDD layer 416 is configured to provide “fault” events to integrated control layer 418 which executes control strategies and policies in response to the received fault events. According to an example embodiment, FDD layer 416 (or a policy executed by an integrated control engine or business rules engine) can shut-down systems or direct control activities around faulty devices or systems to reduce energy waste, extend equipment life, or assure proper control response.

FDD layer 416 can be configured to store or access a variety of different system data stores (or data points for live data). FDD layer 416 can use some content of the data stores to identify faults at the equipment level (e.g., specific chiller, specific AHU, specific terminal unit, etc.) and other content to identify faults at component or subsystem levels. For example, building subsystems 428 can generate temporal (i.e., time-series) data indicating the performance of BMS 400 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

### Graphical User Interfaces of the BMS Building Management System

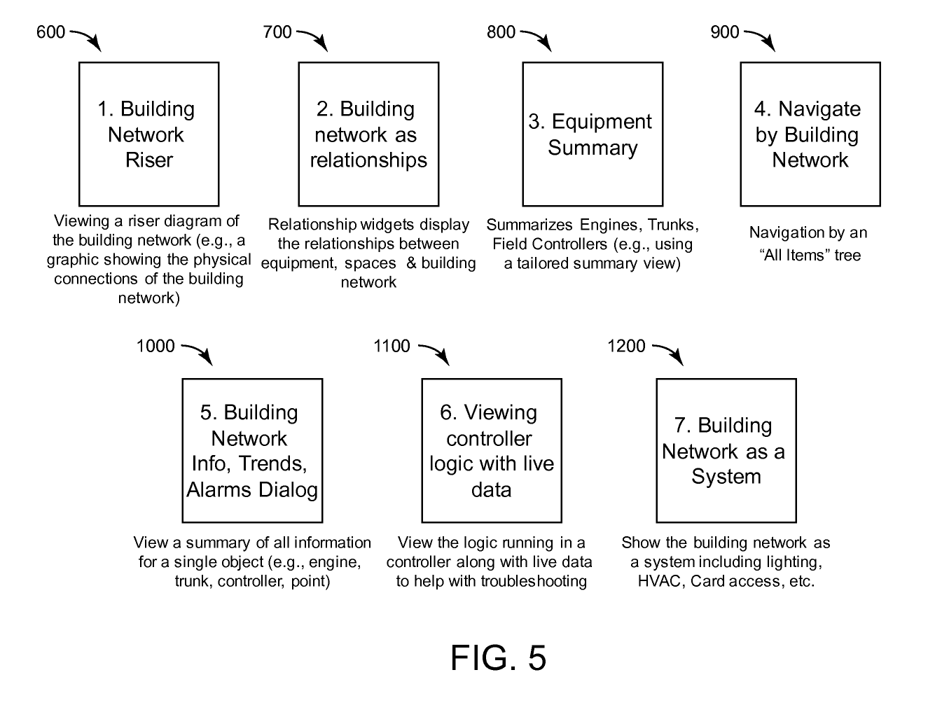

Referring now to FIGS. 5-12, various graphical user interfaces provided by the BMS 400 are shown according to various example embodiments. As shown in FIG. 5, the BMS 400 may provide a building network riser GUI 600, an equipment relationships GUI 700, an equipment summary GUI 800, a building navigation GUI 900, an item information GUI 1000, a live logic GUI 1100, and a system view GUI 1200. The building network riser GUI 600 may be configured to allow a user (e.g., an expert user, an operator, a field technician, etc.) of the BMS 400 to view a riser diagram (e.g., a hierarchical structure, etc.) of a building network (e.g., a graphic showing of the physical connections of equipment of a building network, etc.). The equipment relationships GUI 700 may be configured to allow the user of the BMS 400 to view relationship widgets that display relationships between equipment, spaces, and the building network. The equipment summary GUI 800 may be configured to allow the user of the BMS 400 to view summaries of engines, trunks, field controllers, etc. (e.g., using a tailored summary view, etc.). The building navigation GUI 900 may be configured to allow the user of the BMS 400 to navigate the building network using an item tree. The item information GUI 1000 may be configured to allow the user of the BMS 400 to view a summary of information for a single object (e.g., an engine, a trunk, a controller, a point, etc.). The live logic GUI 1100 may be configured to allow the user of the BMS 400 to view logic running in a controller along with live data (e.g., to help with troubleshooting, etc.). The system view GUI 1200 may be configured to allow the user of the BMS 400 to view the building network as a system including building subsystems (e.g., HVAC subsystem 440, lighting subsystem 442, security subsystem 438, etc.).

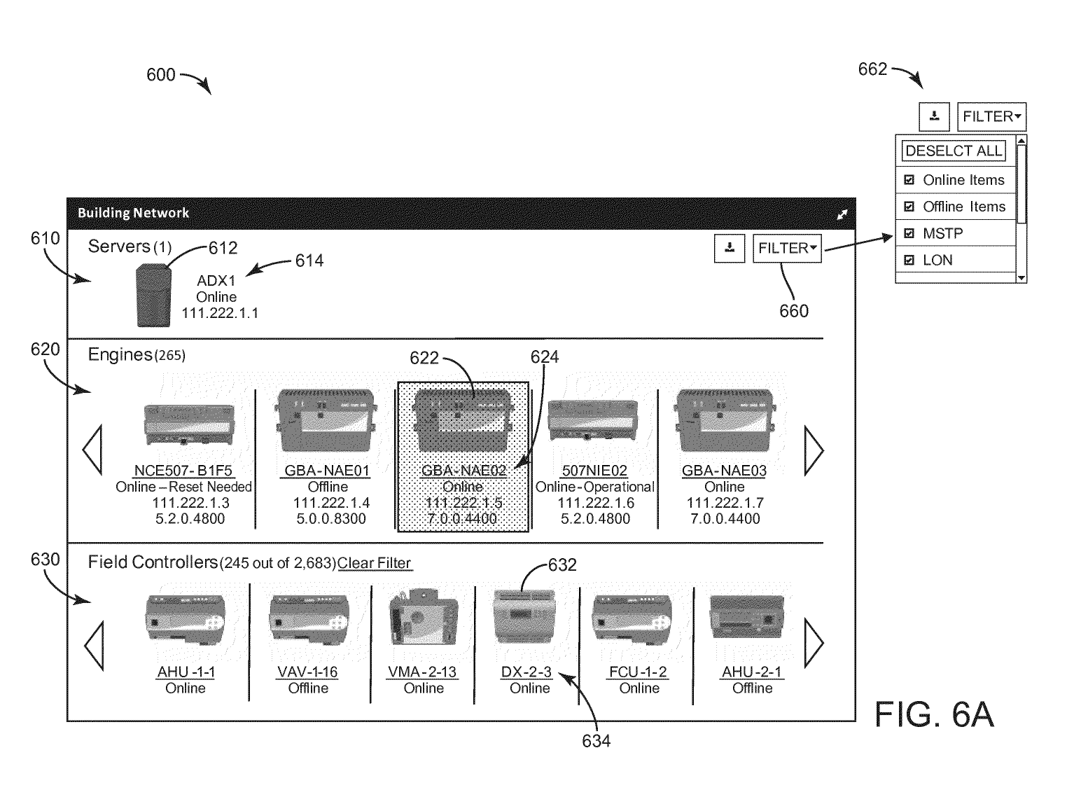

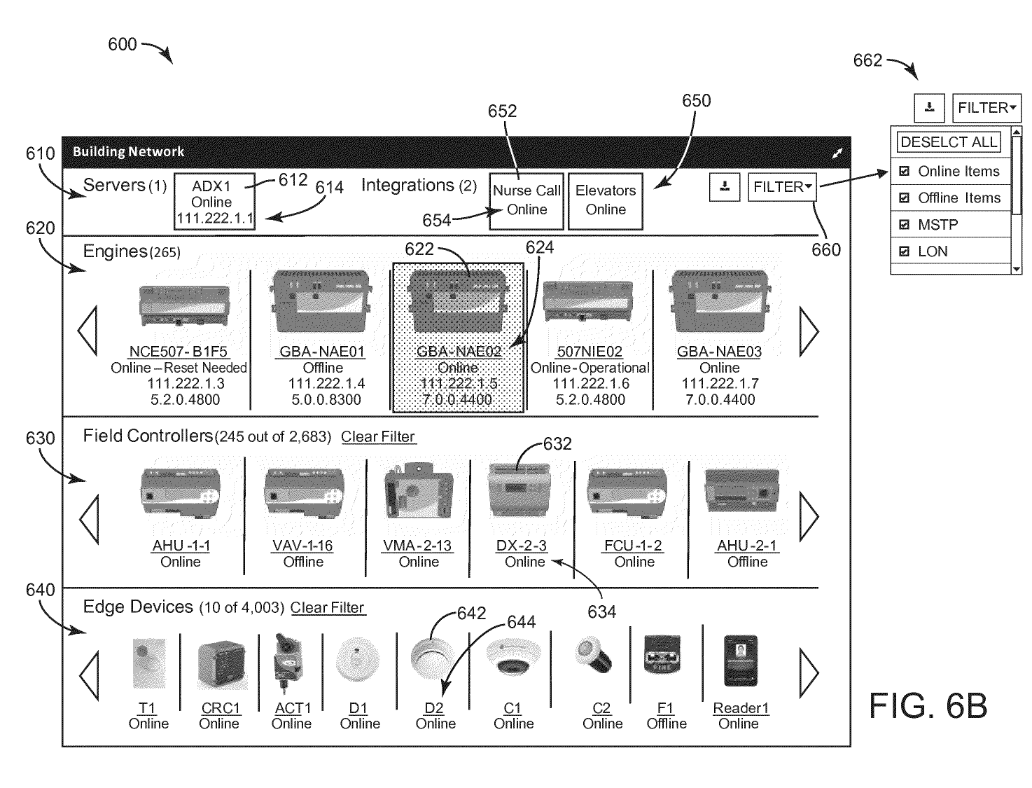

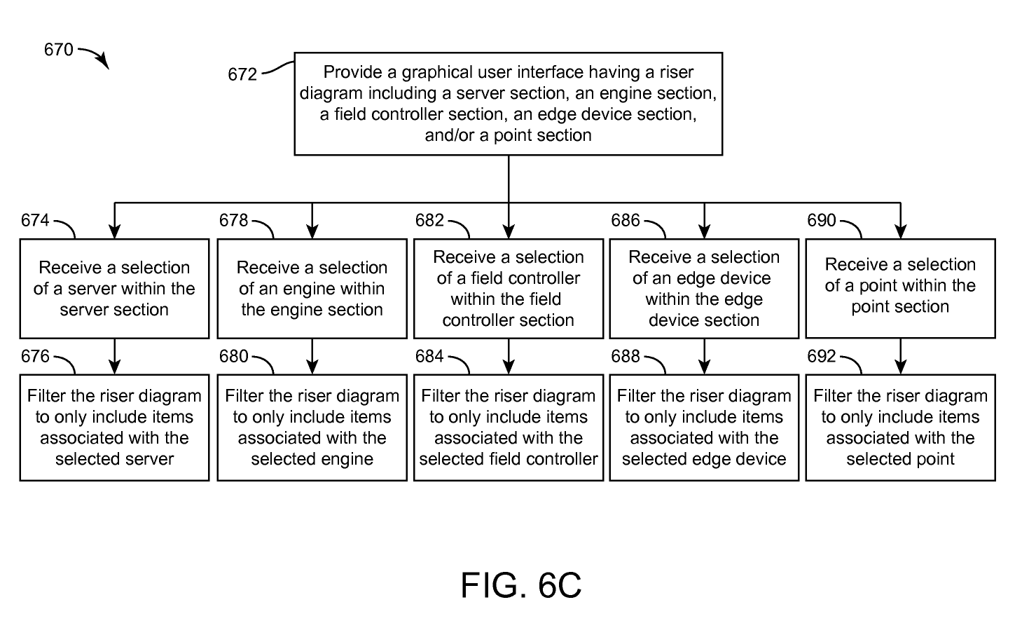

Referring now to FIGS. 6A and 6B, the building network riser GUI 600 is shown according to an example embodiment. As shown in FIGS. 6A and 6B, the building network riser GUI 600 includes a riser diagram (e.g., a hierarchical structure, etc.) of a building network. The building network riser GUI 600 may be used at the beginning of a project (e.g., for setup, installation, etc.) and/or any time after initial setup. As shown in FIGS. 6A and 6B, the building network riser GUI 600 includes a first tier or server section 610, a second tier or an engine section 620, and a third tier or field controller section 630. As shown in FIG. 6B, the building network riser GUI 600 additionally includes a fourth tier or edge device section 640. In some embodiments, the building network riser GUI 600 additionally includes a fifth tier or a point section. In some embodiments, the building network riser GUI 600 includes any combination of the server section 610, the engine section 620, the field controller section 630, the edge device section 640, and/or the point section (e.g., one, two, three, four, five, etc. of the sections). As shown in FIG. 6B, the building network riser GUI 600 additionally includes an integration section 650.

As shown in FIGS. 6A and 6B, the server section 610 includes servers 612 within the building network and accompanying server information 614 (e.g., name, model, status, version, location, IP address, etc.). According to an example embodiment, the servers 612 within the server section 610 include an actual image of the respective server (e.g., for easy identification in the field, etc.). As shown in FIGS. 6A and 6B, the engine section 620 includes engines 622 within the building network and accompanying engine information 624 (e.g., name; model; status—online, offline, online-operational, online-reset needed; version; location; IP address; etc.). The engines 622 may include supervisory controllers of the building network. According to an example embodiment, the engines 622 within the engine section 620 include an actual image of the respective engine (e.g., for easy identification in the field, etc.). As shown in FIGS. 6A and 6B, the field controller section 630 includes field controllers 632 within the building network and accompanying field controller information 634 (e.g., name; model; status—online, offline, online-operational, online-reset needed; version; location; IP address; etc.). According to an example embodiment, the field controllers 632 within the field controller section 630 include an actual image of the respective field controller (e.g., for easy identification in the field, etc.).

As shown in FIG. 6B, the edge device section 640 includes edge devices 642 within the building network and accompanying edge device information 644 (e.g., name; model; status—online, offline, online-operational, online-reset needed; version; location; IP address; etc.). According to an example embodiment, the edge devices 642 within the edge device section 640 include an actual image of the respective edge device (e.g., for easy identification in the field, etc.). The edge devices 642 may include various end user devices and/or room devices such as thermostats, fire alarm devices, fire suppression devices, fire detection devices, carbon monoxide detection devices, lighting devices, security devices, electronic locking mechanisms, cameras, user interfaces (e.g., touchscreen wall devices, etc.), various sensor devices, and the like. According to an example embodiment, the point section includes points within the building network and accompanying point information (e.g., name; status—online, offline, online-operational, online-reset needed; location; IP address; etc.). The points may include individual sensors configured to acquire readings such as temperature, humidity, light intensity, occupancy, motion, etc. As shown in FIG. 6B, the integration section 650 includes integrated systems 652 that are integrated within the building network and accompanying integration information 654 (e.g., name; model; status—online, offline, online-operational, online-reset needed; etc.). The integrated systems 652 may include systems such as a nurse call system, elevator systems, a visitor management system, a terminal management system, etc.

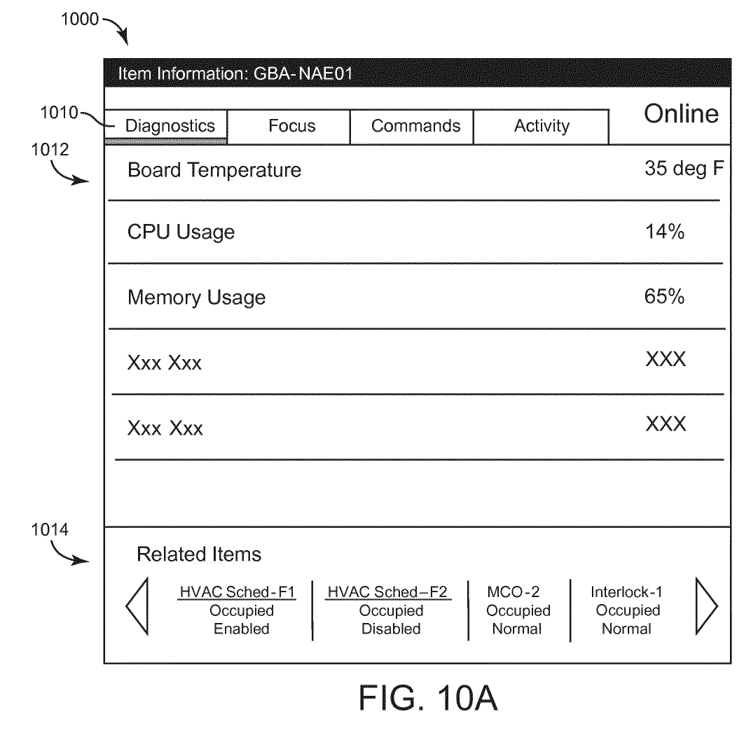

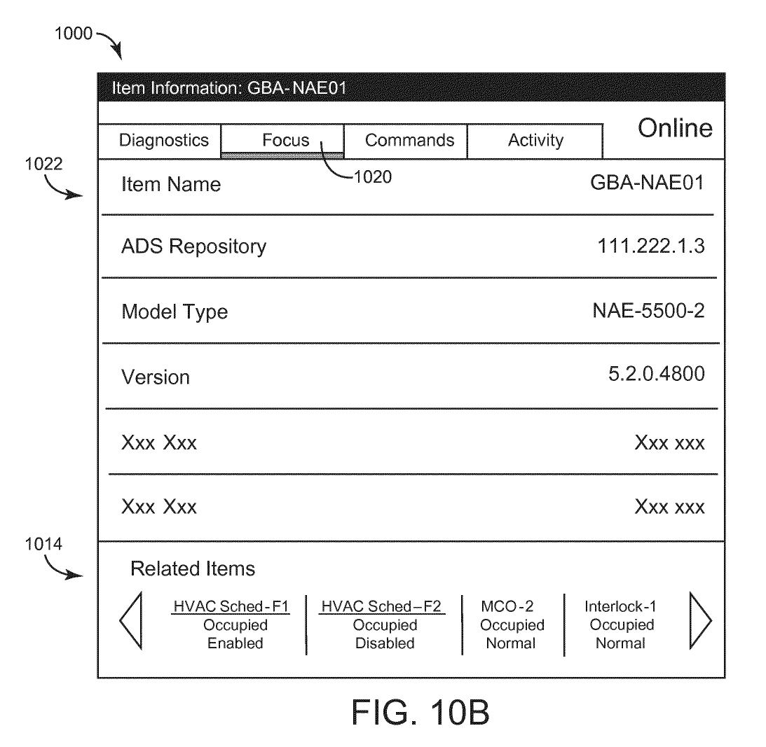

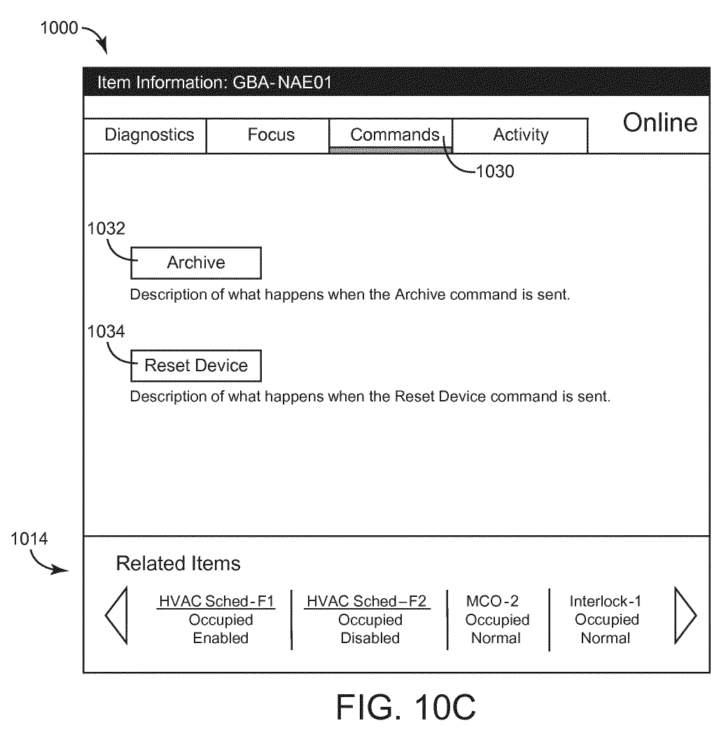

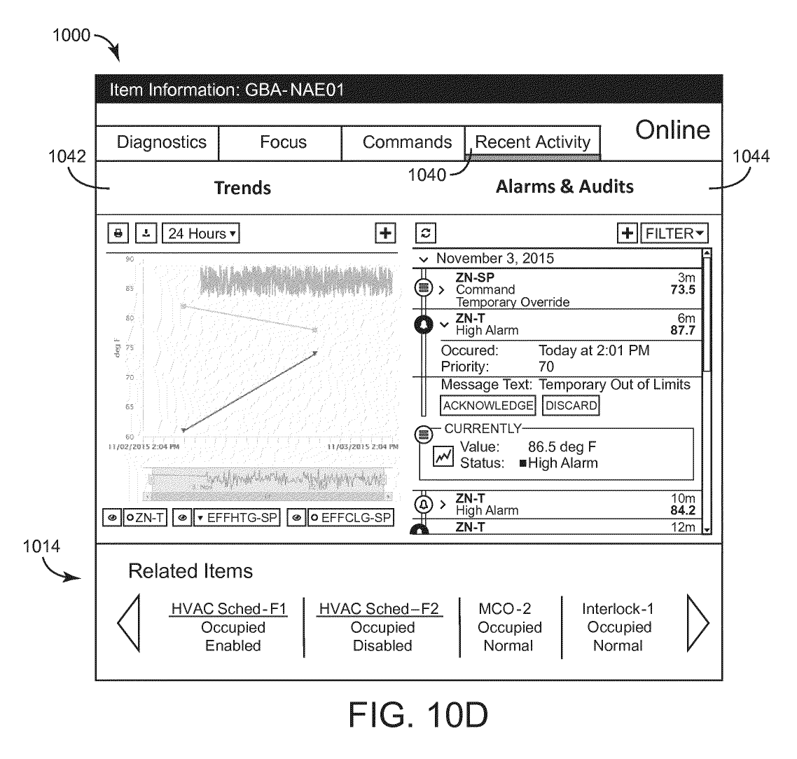

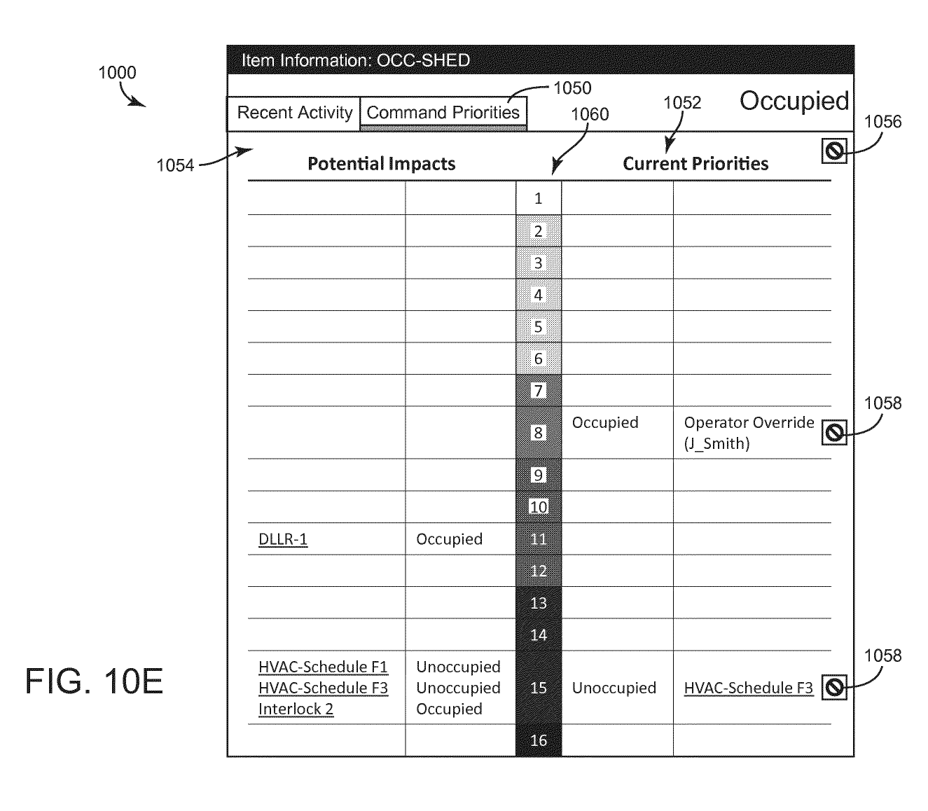

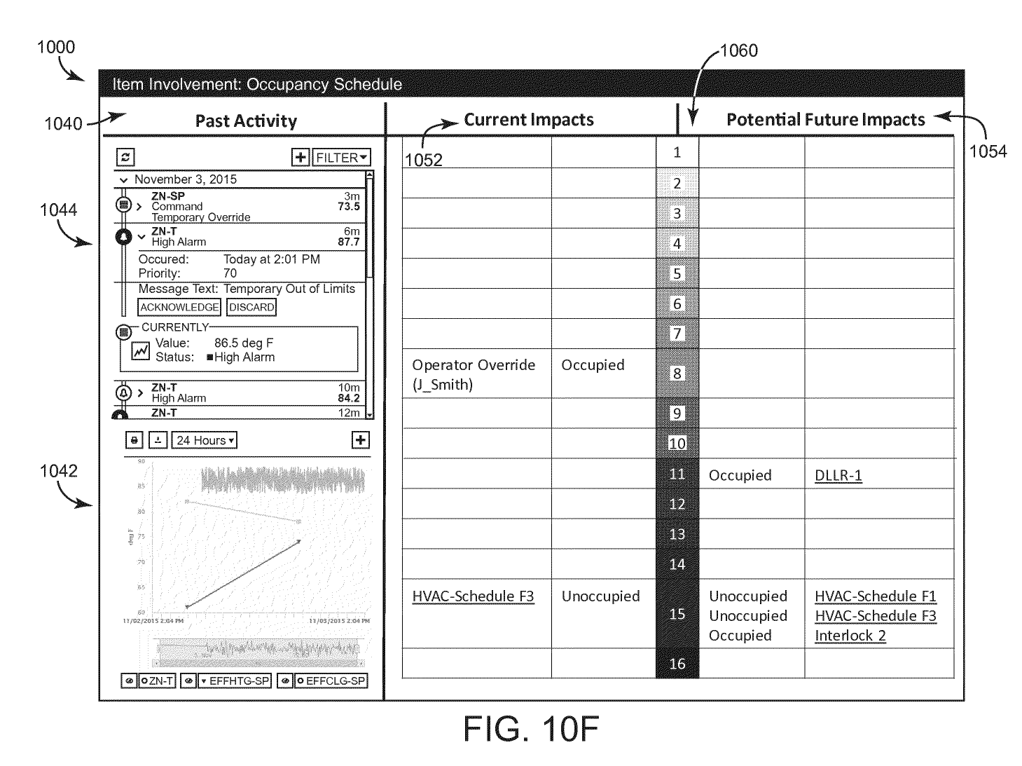

The BMS 400 may be configured to integrate into any type of system and facilitate accessing any and all devices (e.g., servers 612, engines 622, field controllers 632, edge devices 642, etc.) and/or points within the building network (e.g., through the building network riser GUI 600, etc.). According to an example embodiment, the user of the building network riser GUI 600 may click on a selectable link within the server information 614, the engine information 624, the field controller information 634, the edge device information 644, and/or the point information to be directed to an item/equipment information dialog for the selected equipment (see, e.g., FIGS. 10A-10F, the item information GUI 1000, etc.).

As shown in FIGS. 6A and 6B, the building network riser GUI 600 includes a filter button 660 that is configured to provide various filtering options 662 (e.g., online items, offline items, MSTP, LON, etc.) for filtering the servers 612, the engines 622, the field controllers 632, the edge device 642, and/or the points displayed by the building network riser GUI 600. According to an example embodiment, the building network riser GUI 600 may automatically sort and/or filter based on selections made by the user on the building network riser GUI 600 (e.g., see FIG. 6C). By way of example, the building network riser GUI 600 may undergo various filtering operations based on user selections within the server section 610, the engine section 620, the field controller section 630, the edge device section 640, the point section, and/or the integration section 650 (e.g., selecting any item of the building network riser GUI 600 may filter the items to show the direct hierarchical relationships, etc.). In some embodiments, an operator is able to filter the building network riser GUI 600 based on particular version(s), status (e.g., online, offline, etc.), age (e.g., everything that is near or past end-of-life, etc.), etc. of the servers 612, the engines 622, the field controllers 632, the edge device 642, and/or the points.

As shown in FIG. 6C, a method 670 for filtering a building network riser GUI (e.g., the building network riser GUI 600, etc.) is shown according to an example embodiment. At step 672, a controller (e.g., the BMS 400, etc.) is configured to provide a graphical user interface (e.g., the building network riser GUI 600, etc.) having a riser diagram including a first tier or server section (e.g., the server section 610, etc.) including one or more servers (e.g., the servers 612, etc.), a second tier or an engine section (e.g., the engine section 620, etc.) including one or more engines (e.g., the engines 622, etc.), a third tier or a field controller section (e.g., the field controller section 630, etc.) including one or more field controllers (e.g., the field controllers 632, etc.), a fourth tier or edge device section (e.g., the edge device section 640, etc.) including one or more edge devices (e.g., the edge devices 642, etc.), and/or a fifth tier or point section including one or more points.

At step 674, the controller is configured to receive a selection of a server within the server section. At step 676, the controller is configured to filter the riser diagram to only include items associated with the selected server. By way of example, the controller may be configured to filter out all other servers except for the selected server, all engines except for children engines of the selected server, all field controllers except for children field controllers of the selected server, all edge devices except for children edge device of the selected server, and all points except for children points of the selected server.

At step 678, the controller is configured to receive a selection of an engine within the engine section. At step 680, the controller is configured to filter the riser diagram to only include items associated with the selected engine. By way of example, the controller may be configured to filter out all servers except for ancestor servers of the selected engine, all other engines except for the selected engine, all field controllers except for children field controllers of the selected engine, all edge devices except for children edge device of the selected engine, and all points except for children points of the selected engine.

At step 682, the controller is configured to receive a selection of a field controller within the field controller section. At step 684, the controller is configured to filter the riser diagram to only include items associated with the selected field controller. By way of example, the controller may be configured to filter out all servers except for ancestor servers of the selected field controller, all engines except for parent engines of the selected field controller, all other field controllers except for the selected field controller, all edge devices except for children edge devices of the selected field controller, and all points except for children points of the selected field controller.

At step 686, the controller is configured to receive a selection of an edge device within the edge device section. At step 688, the controller is configured to filter the riser diagram to only include items associated with the selected edge device. By way of example, the controller may be configured to filter out all servers except for ancestor servers of the selected edge device, all engines except for parent engines of the selected edge device, all field controllers except for the parent field controllers of the selected edge device, all other edge devices except for the selected edge device, and all points except for children points of the selected edge device.

At step 690, the controller is configured to receive a selection of a point within the point section. At step 692, the controller is configured to filter the riser diagram to only include items associated with the selected point. By way of example, the controller may be configured to filter out all servers except for ancestor servers of the selected point, all engines except for parent engines of the selected point, all field controllers except for the parent field controllers of the selected point, all edge devices except for the parent edge devices of the selected point, and all other points except for the selected point.

In some embodiments, the controller is configured to provide the graphical user interface such that the riser diagram additionally includes an integration section (e.g., the integration section 650, etc.) including one or more integrated systems (e.g., the integrated systems 652, etc.). The controller may be configured to receive a selection of an integrated system within the integration section. The controller may be further configured to filter out all servers, engines, field controllers, edge devices, and points except for the servers, engines, field controllers, edge devices, and points associated with the selected integrated system.

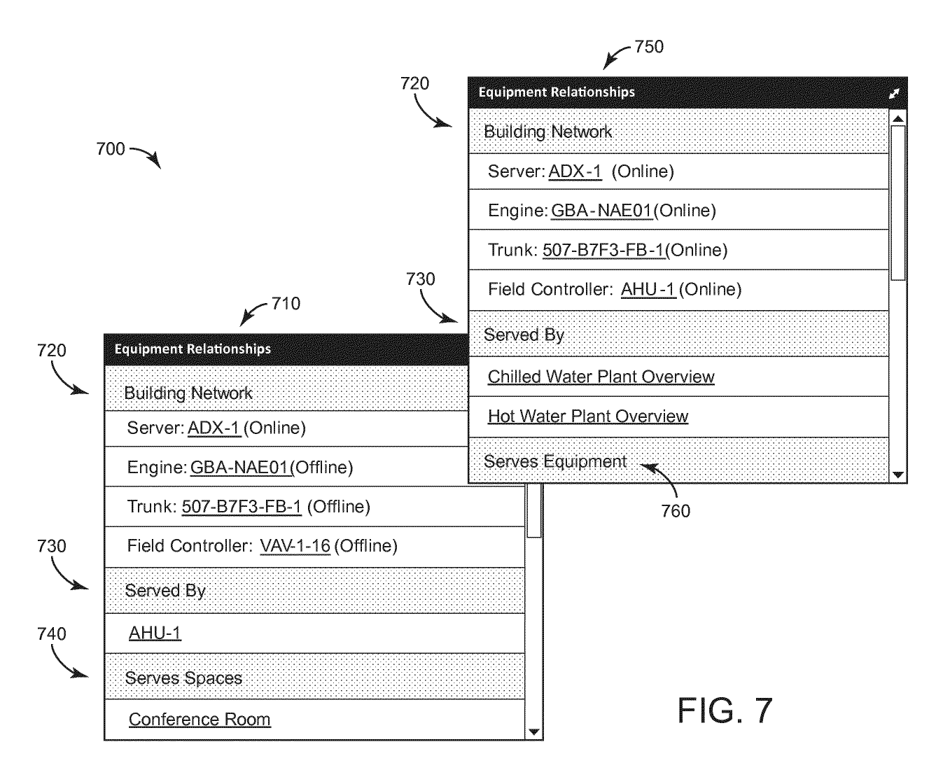

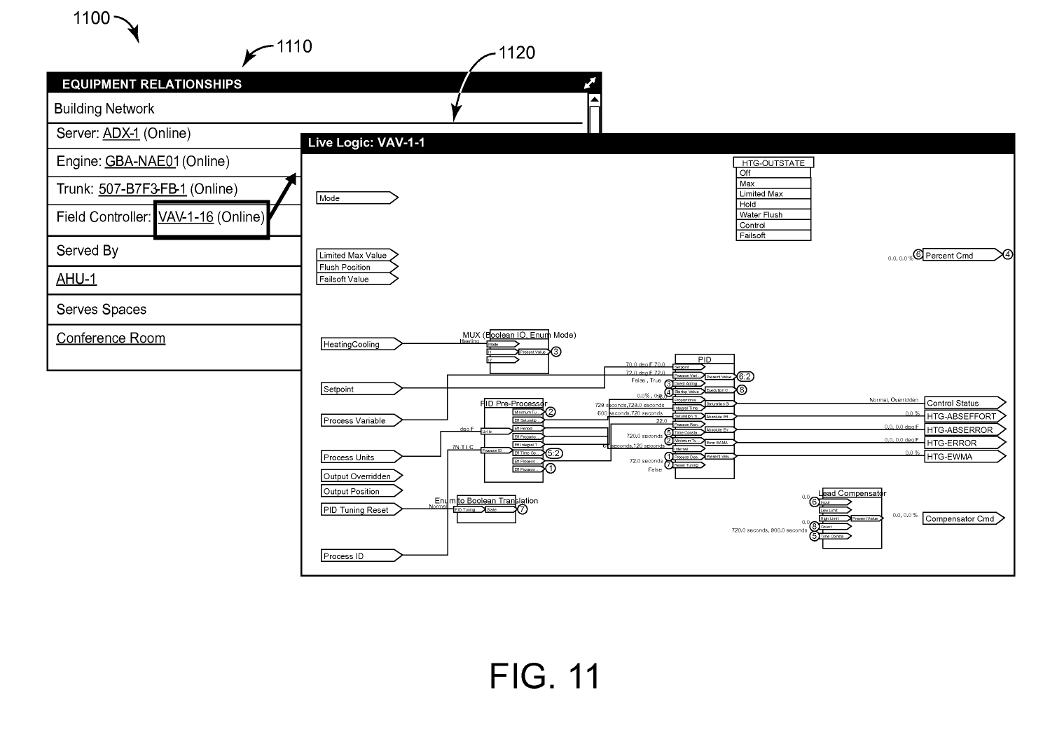

Referring now to FIG. 7, the equipment relationships GUI 700 is shown according to an example embodiment. The equipment relationships GUI 700 may be configured to allow the user of the BMS 400 to view relationship widgets that display relationships between equipment, spaces, and the building network. As shown in FIG. 7, the equipment relationships GUI 700 includes a first equipment relationships GUI 710 and a second equipment relationships GUI 750. The first equipment relationships GUI 710 and the second relationships GUI 750 include a building network section 720 that shows a full network tree for respective equipment (e.g., servers, engines, trunks, field controllers, etc.). The first equipment relationships GUI 710 and the second relationships GUI 750 may additionally include a served by section 730. The served by section 730 may indicate what systems the equipment of the building network section 720 serve. The first equipment relationships GUI 710 and/or the second relationships GUI 750 may additionally include a serves spaces section 740. The serves spaces section 740 may indicate spaces the equipment of the building network section 720 serve (e.g., conference room, cafeteria, etc.). The first equipment relationships GUI 710 and/or the second relationships GUI 750 may additionally include a serves equipment section 760. The serves equipment section 760 may indicate equipment the equipment of the building network section 720 serve. According to an example embodiment, a user of the equipment relationships GUI 700 may click on a selectable link within the equipment relationships GUI 700 to be directed to further information about the network and/or the selected item (see, e.g., FIGS. 10A-10F, the item information GUI 1000; FIG. 6, the building network riser GUI 600; FIG. 11, the live logic GUI 1100; etc.).

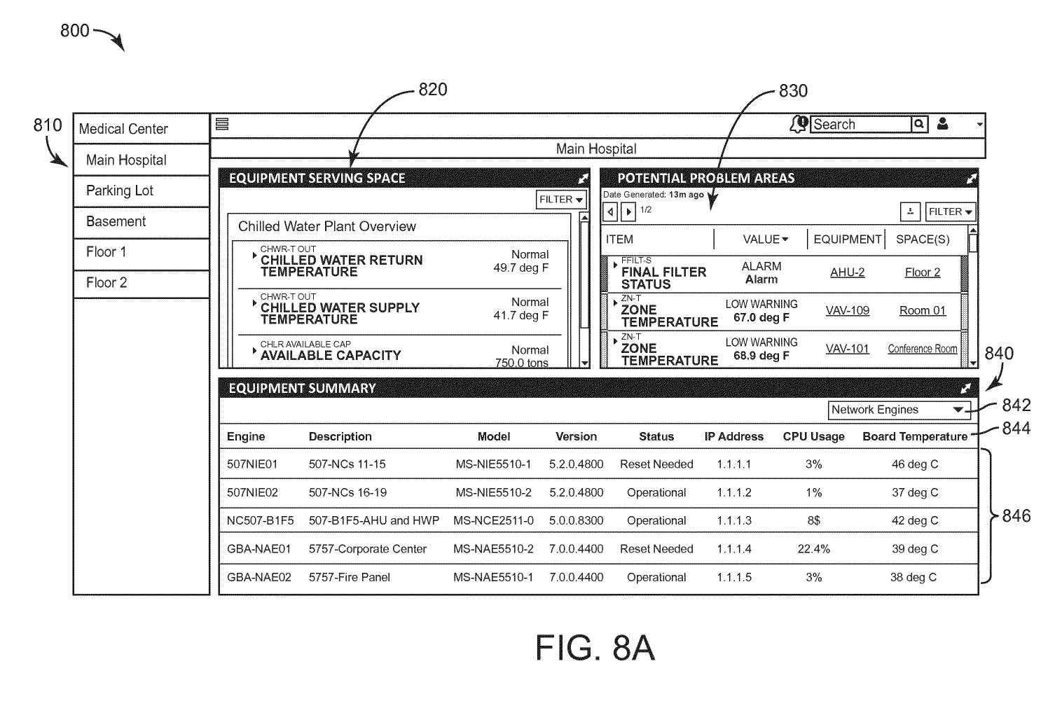

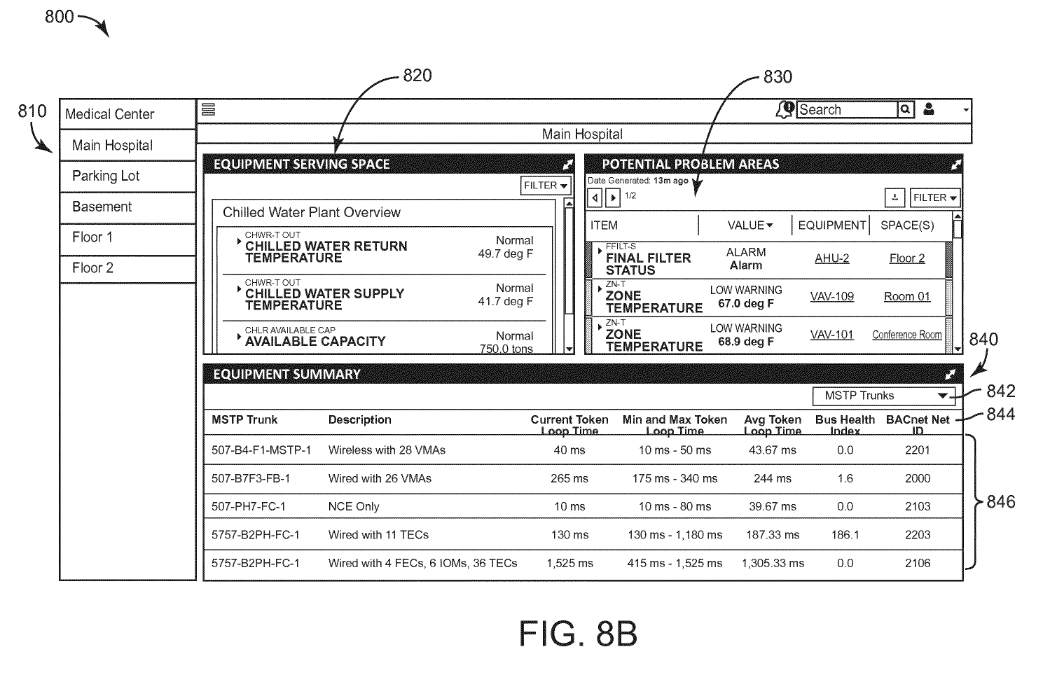

Referring now to FIGS. 8A and 8B, the equipment summary GUI 800 is shown according to various example embodiments. The equipment summary GUI 800 may be configured to allow the user of the BMS 400 to view summaries of engines, trunks, field controllers, etc. (e.g., using a tailored summary view, etc.). As shown in FIGS. 8A and 8B, the equipment summary GUI 800 includes a navigation panel 810, an equipment serving space section 820, a potential problem areas section 830, and an equipment summary section 840. According to an example embodiment, the navigation panel 810 facilitates selecting between various locations or spaces of interest in a building (e.g., a main building, a parking lot, a basement, a floor level, etc.). The equipment serving space section 820 may provide various information (e.g., temperature, capacity, etc.) about the operation of various equipment serving the space selected via the navigation panel 810. The potential problem areas section 830 may provide various notifications, alerts, and/or warnings (e.g., temperature warnings, filter status, etc.) relating to the operation of various equipment serving the space selected via the navigation panel 810.

As shown in FIGS. 8A and 8B, the equipment summary section 840 includes a user selectable drop down menu 842, an attribute listing 844, and an equipment listing 846. According to an example embodiment, the user selectable drop down menu 842 facilitates selecting a type of equipment (e.g., engines, trunks, field controllers, servers, etc.) of interest that are serving the space selected via the navigation panel 810. As shown in FIG. 8A, the engines of the selected space are chosen. Thus, the attribute listing 844 includes various attributes relating to engines of the selected space. As shown in FIG. 8A, the attribute listing 844 includes engine name, description, model, version, status, IP address, CPU usage, and board temperature. The attribute listing 844 may additionally or alternatively include ADS repository, last archive date, local engine time, object count, Ethernet MAC address, IP mask, BACnet object name, network address, BACnet IP port, object identifier, instance number, BACnet broadcast receive rate, and/or still other attributes. The equipment listing 846 may be configured to populate with attributes according to the attribute listing 844 corresponding with the type of equipment selected via the user selectable drop down menu 842 (e.g., engines, etc.). As shown in FIG. 8B, the trunks of the selected space are chosen. Thus, the attribute listing 844 includes various attributes relating to trunks of the selected space. As shown in FIG. 8B, the attribute listing 844 includes trunk name, description, current token loop time, average token loop time, BUS health index, and BACnet Net ID. The attribute listing 844 may additionally or alternatively include other attributes. The equipment listing 846 may be configured to populate with attributes according to the attribute listing 844 corresponding with the type of equipment selected via the user selectable drop down menu 842 (e.g., trunks, etc.). The above description is related to MSTB trunks, but may also apply to N2 controllers, FEC controllers, LON controllers, and/or TEC controllers (e.g., which may include different attribute and/or data, etc.).

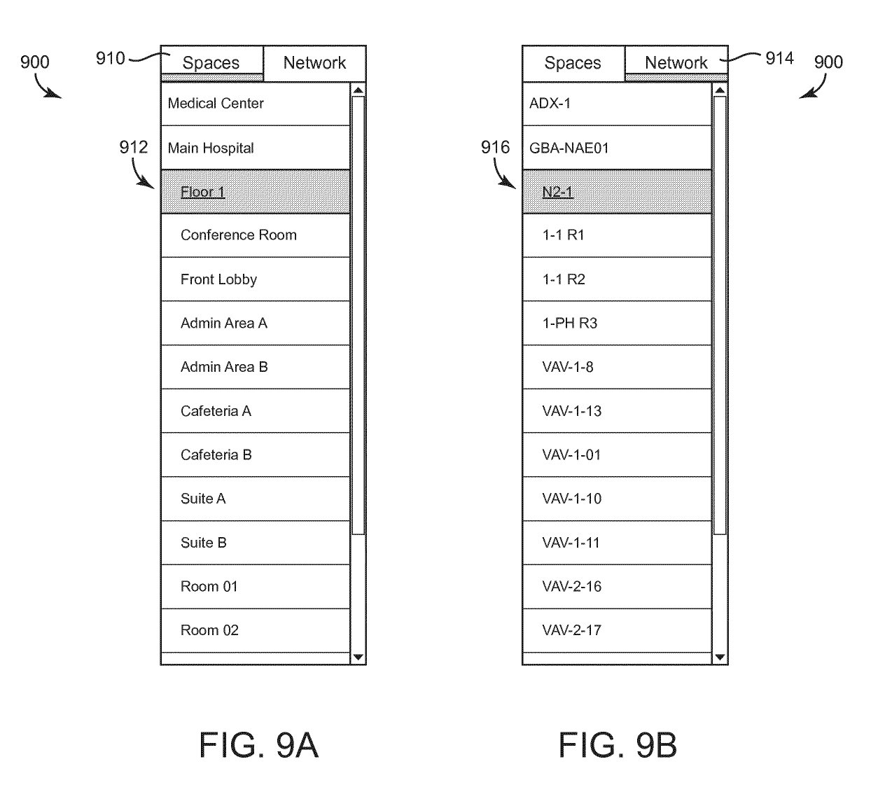

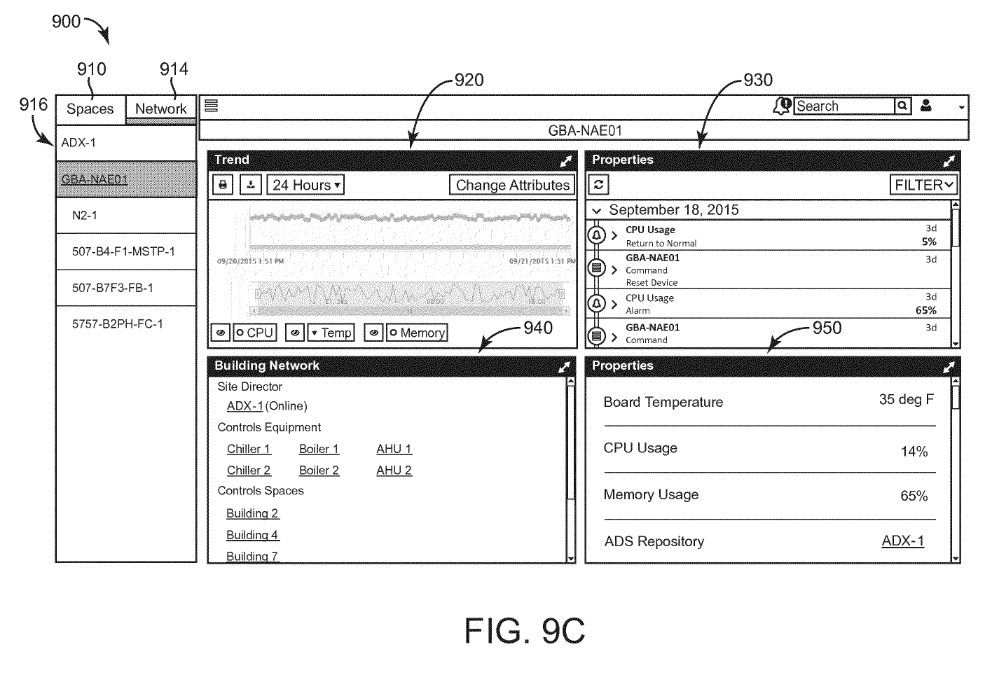

Referring now to FIGS. 9A-9C, the building navigation GUI 900 is shown according to various example embodiments. The building navigation GUI 900 may be configured to allow the user of the BMS 400 to navigate the building network using an item tree. As shown in FIGS. 9A-9C, the building navigation GUI 900 includes a navigation tree having a spaces tab 910 and a network tab 914. According to the example embodiment shown in FIG. 9A, selecting the spaces tab 910 displays a spaces navigation tree 912 that includes various spaces associated with a building that can be accessed/navigated (e.g., floor levels, conference rooms, room numbers, cafeterias, etc.). According the example embodiment shown in FIGS. 9B and 9C, selecting the network tab 914 displays a networks navigation tree 916 that includes various networks associated with a building that can be accessed/navigated. As shown in FIG. 9C, the building navigation GUI 900 may additionally include a trend section 920, an activity section 930, a relationships section 940, and a properties section 950. The trend section 920 may display various trends (e.g., CPU usage, temperature, memory usage, etc.) regarding the equipment associated with the selected space and/or network. The activity section 930 may display various activities (e.g., alarms, commands, etc.) regarding the equipment associated with the selected space and/or network. The relationships section 940 may display various relationships between equipment associated with the selected space and/or network. The properties section 950 may display various current properties (e.g., board temperature, CPU usage, memory usage, etc.) regarding the equipment associated with the selected space and/or network.

Referring now to FIGS. 10A-10F, the item information GUI 1000 is shown according to an example embodiment. The item information GUI 1000 may be configured to allow the user of the BMS 400 to view a summary of information for a single object (e.g., an engine, a trunk, a controller, a point, etc.). The item information GUI 1000 may display (e.g., at any time, etc.) a selected point and/or object of the BMS 400. The user may be able to view point/object information. The user may be able to additionally or alternatively command the point/object and view trend, audit, and/or alarm activity associated with the point/object. The item information GUI 1000 may apply to field points (e.g., DA-T, ZN-T, etc.), as well as building network objects (e.g., engines, trunks, field controllers, etc.).

As shown in FIGS. 10A-10F, the item information GUI 1000 includes various tabs including a diagnostic tab 1010, a focus tab 1020, a commands tab 1030, an activity tab 1040, and a command priorities tab 1050. As shown in FIG. 10A, the item information GUI 1000 is configured to display diagnostics information 1012 in response to the diagnostics tab 1010 being selected. According to the example shown in FIG. 10A, the diagnostics information 1012 is for a selected engine and includes engine attributes such as board temperature, CPU usage, memory usage, etc. The diagnostics information 1012 may include different attributes for each point and/or object being displayed (e.g., engines, trunks, field controllers, points, servers, etc.) by the item information GUI 1000. As shown in FIGS. 10A-10D, the item information GUI 1000 may additionally include related items 1014 that show point involvement (e.g., field controllers, trunks, engines, ADS, etc.). The related items 1014 may include graphics (e.g., similar to the building network riser GUI 600, etc.). The relationship between the selected item of the item information GUI 1000 and the related items 1014 may be configuration relationships (e.g., rather than diagnostic relationships, etc.).

As shown in FIG. 10B, the item information GUI 1000 is configured to display focus information 1022 in response to the focus tab 1020 being selected. According to the example shown in FIG. 10B, the focus information 1022 is for a selected engine and includes engine attributes such as item name, model type, version, etc. The focus information 1022 may include different attributes for each point and/or object (e.g., engines, trunks, field controllers, edge devices, points, servers, etc.) being displayed by the item information GUI 1000.

As shown in FIG. 10C, the item information GUI 1000 is configured to display a plurality of commands, shown as commands 1032 and 1034, in response to the commands tab 1030 being selected. According to the example shown in FIG. 10C, the commands 1032 and 1034 are commands for a selected engine. The commands tab 1030 may include different commands for each point and/or object (e.g., engines, trunks, field controllers, edge devices, points, servers, etc.) being displayed by the item information GUI 1000. In some embodiments, the commands tab 1030 displays a greater number or a lesser number of commands (e.g., one, three, five, etc.). As shown in FIG. 10C, the commands 1032 and 1034 for the engine include an archive command and a reset engine command. In some embodiments, the engine commands may additionally or alternatively include an enable/disable alarms command and/or a route samples command. In embodiments where the item information GUI 1000 is displaying information for a field controller, the commands tab 1030 may include field controller commands such as an enable command, a disable command, a reset field controller command, etc. In embodiments where the item information GUI 1000 is displaying information for a point, the commands tab 1030 may include point commands such as a release command, a release all command, a set default value command, etc.

As shown in FIG. 10D, the item information GUI 1000 is configured to display trend information 1042 and alarm and audit information 1044 in response to the recent activity tab 1040 being selected. According to the example shown in FIG. 10D, the trend information 1042 and the alarms and audit information 1044 is for a selected engine. The trend information 1042 and the alarms and audit information 1044 may include different trends, alarms, and/or audit information for each point and/or object (e.g., engines, trunks, field controllers, edge device, points, servers, etc.) being displayed by the item information GUI 1000. The trend information 1042 may display various trends (e.g., CPU usage, temperature, memory usage, etc.) regarding the selected object or point. The alarm and audit information 1044 may display alarms and command audit trails associated with the selected object or point.

The recent activity tab 1040 may additionally provide a configuration functionality to support a user's troubleshooting workflow (e.g., when no trend/alarm has been created, etc.) including a quick create of trend extension functionality, a quick create of alarm functionality, a change of alarm limits (or other alarm configuration information) functionality, a change trend sample interval (or other trend configuration information) functionality, an enable/disable trends functionality, and enable/disable alarms functionality, an averaging information functionality, a totalization information functionality, a temporary trend functionality (e.g., a trend that is created and live for a duration and then disabled, etc.), and/or an automatic change sample interval while a point is in an alarm status functionality, among other possible functionalities.

As shown in FIG. 10E, the item information GUI 1000 is configured to display current priorities 1052 and potential impacts 1054 in response to the command priorities tab 1050 being selected. According to an example embodiment, the command priorities tab 1050 provides a single view of priorities and potential impact of commands and allows a user to control an entire building. According to the example shown in FIG. 10E, the command priorities tab 1050 displays the current priorities 1052 and the potential impacts 1054 for a selected point. The command priorities tab 1050 may display (i) historical changes (e.g., alarms, audits, trends, etc.) for the selected point (e.g., everything that has affected the point, etc.), (ii) commands or changes that could potentially affect the point, and/or (iii) commands or changes that are currently affecting the point.

As shown in FIG. 10E, the item information GUI 1000 is configured to display a priority array 1060 in response to the command priorities tab 1050 being selected. The priority array 1060 is configured to display the current priorities 1052 in order from the highest priority (e.g., 1) to the lowest priority (e.g., 16). In some embodiments, the item information GUI 1000 is configured to display descriptions of what each level of the priority array represents (e.g., 8 indicates manual operator overrides; 15 indicates features including scheduling, interlocks, multiple command objects; etc.). The descriptions may be displayed in response to a user selecting or hovering over a desired priority level. The descriptions may alternatively be displayed in a separate area of the item information GUI 1000.

According to an example embodiment, the command priorities tab 1050 of the item information GUI 1000 is configured to bring the priority embedded within a protocol (e.g., a command, etc.) to the surface. Therefore, based on occupancy schedules (e.g., which operate differently if point is occupied or unoccupied, etc.), the user may look at various commands and priorities to determine which takes priority. As shown in FIG. 10E, the command priorities tab 1050 may include a release all priorities button 1056 configured to facilitate releasing all priorities currently impacting the selected point and/or a release a single priority button 1058 configured to facilitate releasing a single priority at a time that is currently impacting the selected point. The ability of a user to input a command and/or remove a command may be based on a permission level of the user. The permission level of the user may also be taken into account when prioritizing the commands of the current priorities 1052 (e.g., a building manager command may be a higher priority than a technician, etc.). In some embodiments, the command priorities tab 1050 displays when (e.g., date, time, etc.) and by whom a command was issued and/or removed.

As shown in FIG. 10F, the item information GUI 1000 may combine information from the recent activity tab 1040 and the command priorities tab 1050 into a single, cohesive interface. As shown in FIG. 10F, the item information GUI 1000 is configured to display (i) the trend information 1042 and alarm and audit information 1044 from the recent activity tab 1040 (of FIG. 10D) and (ii) the current priorities 1052, the potential impacts 1054, and the priority array 1060 of the command priorities tab 1050 into a single interface. The item information GUI 1000 of FIG. 10F may thereby facilitate displaying information regarding the past, present, and future of a selected point. By way of example, the item information GUI 1000 may display the past, present, and future information for a door within a building. For example, the item information GUI 1000 may display the current status of an electronic lock of the door (e.g., locked, unlocked, etc.), the past access to the door (e.g., who has gone through the door, based on access card swipes, etc.), and who has permission to access the door in the future. In some embodiments, the item information GUI 1000 of FIG. 10F does not include the priority array 1060. In some embodiments, the information from the item information GUI 1000 for a plurality of points is displayed in a summary report.

Referring now to FIG. 11, the live logic GUI 1100 is shown according to an example embodiment. The live logic GUI 1100 may be configured to allow the user of the BMS 400 to view logic running in a controller along with live data (e.g., to help with troubleshooting, etc.). As shown in FIG. 11, the live logic GUI 1100 includes an equipment relationships section 1110 (e.g., similar to the equipment relationships GUI 700, etc.) and a live logic section 1120. By way of example, a user may access the live logic section 1120 by selecting on a selectable link (e.g., of a field controller, etc.) within the equipment relationships section 1110. The live logic section 1120 may display the logic running in the selected field controller along with live data inputs and/or live data outputs of the logic. By way of example, this may provide users with the ability to inspect the logic of the field controllers to understand and locate exactly where an issue may be occurring. For example, the live logic section 1120 may provide users with the ability to determine if the issue is with the mechanical equipment (e.g., of the field controller, of equipment being controlled by the field controller, etc.) or in the application logic itself. The live logic section 1120 may additionally allow a user to view and edit the logic of the field controller to correct issues within the logic itself. The live logic section 1120 may additionally allow for download and/or saving to the field controller without download (e.g., while offline, etc.).

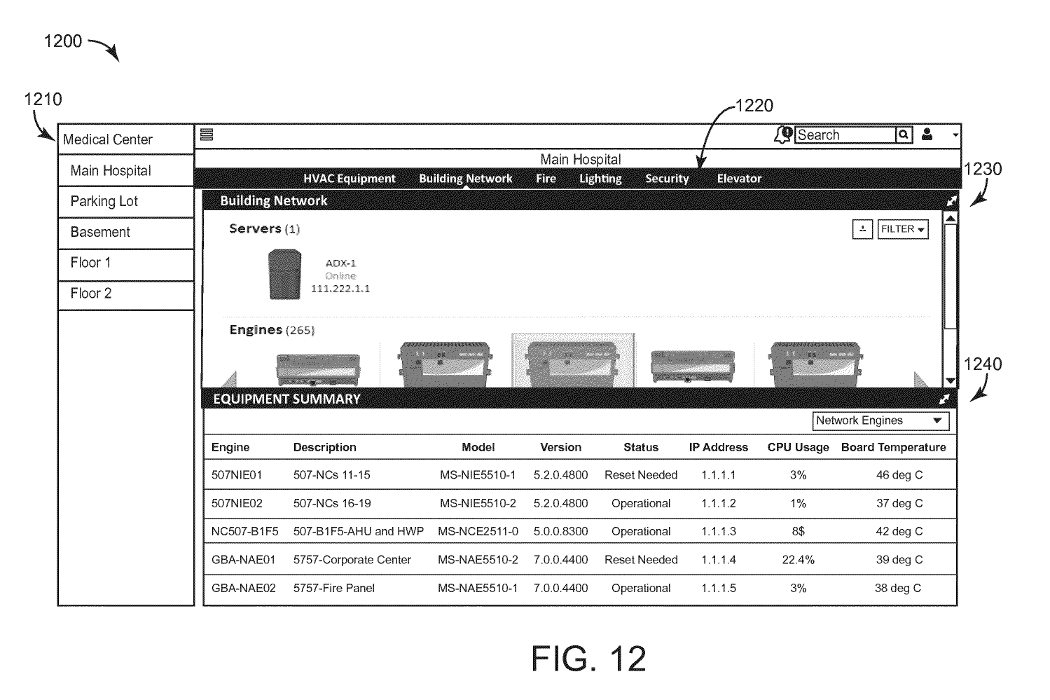

Referring now to FIG. 12, the system view GUI 1200 is shown according to an example embodiment. The system view GUI 1200 may be configured to allow the user of the BMS 400 to view the building network as a system including building subsystems (e.g., HVAC subsystem 440, lighting subsystem 442, security subsystem 438, etc.). As shown in FIG. 12, the system view 1200 includes a navigation tree 1210 (e.g., similar to the space navigation tree 912, the network navigation tree 916, etc.) configured to facilitate selecting a desired space (or network) for display. The system view 1200 additionally includes an equipment dashboard 1220 configured to facilitate filtering between subsystems for display in a display section 1230 and a summary section 1240. As shown in FIG. 12, the subsystems of the equipment dashboard 1220 include HVAC equipment, building network, fire, lighting, security, and elevator, among other possible building subsystems (e.g., electrical, ICT, etc.). The display section 1230 and the summary section 1240 may provide various information about the selected subsystem from the equipment dashboard 1220. According to the example shown in FIG. 12, the display section 1230 includes the building network riser GUI 600 in response to the building network subsystem being selected from the equipment dashboard 1220. According to the example shown in FIG. 12, the summary section 1240 includes the equipment summary section 840 of the equipment summary GUI 800 in response to the building network subsystem being selected from the equipment dashboard 1220 (e.g., to display more details about the engines, trunks, field controllers, servers, etc. of the building network riser GUI 600, etc.).

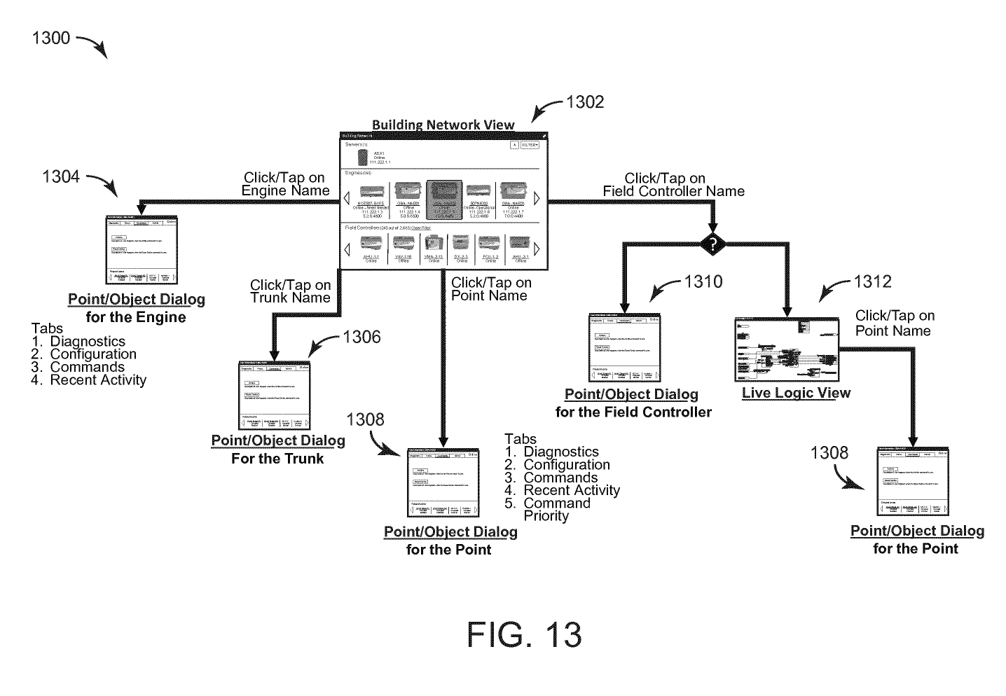

Referring now to FIGS. 13-16, various graphical flow diagrams of navigating through the GUIs 700-1200 are shown according to various example embodiments. As shown in FIG. 13, a user may start from a building network view 1302 (e.g., the building network riser GUI 600, etc.). The user may then proceed to (i) a point/object dialog for an engine 1304 (e.g., the item information GUI 1000 including the diagnostics tab 1010, the focus tab 1020, the commands tab 1030, and the recent activity tab 1040 for the selected engine, etc.) in response to selecting a respective engine name on the building network view 1302, (ii) a point/object dialog for an a trunk 1306 (e.g., the item information GUI 1000 including the diagnostics tab 1010, the focus tab 1020, the commands tab 1030, and the recent activity tab 1040 for the selected trunk, etc.) in response to selecting a respective trunk name on the building network view 1302, (iii) a point/object dialog for a point 1308 (e.g., the item information GUI 1000 including the diagnostics tab 1010, the focus tab 1020, the commands tab 1030, the recent activity tab 1040, and the command priorities tab 1050 for the selected point, etc.) in response to selecting a respective point name on the building network view 1302, and/or (iv) at least one of (a) a point/object dialog for a field controller 1310 (e.g., the item information GUI 1000 including the diagnostics tab 1010, the focus tab 1020, the commands tab 1030, and the recent activity tab 1040 for the selected field controller, etc.) and (b) a live logic view 1312 (e.g., the live logic GUI 1100, etc.) in response to selecting a respective field controller name on the building network view 1302. The user may proceed from the live logic view 1312 to the point/object dialog for a point 1308 in response to selecting a respective point name on the live logic view 1312.

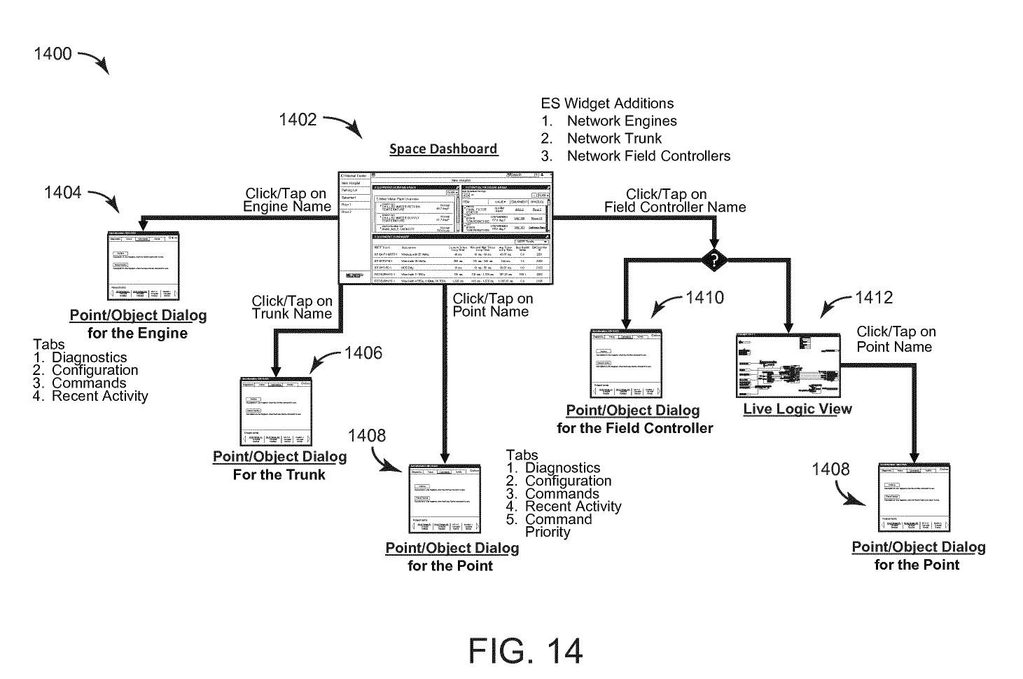

As shown in FIG. 14, a user may start from a space dashboard 1402 (e.g., the equipment summary GUI 800, the building navigation GUI 900, etc.; having network engines, trunks, and/or field controllers, etc.). The user may then proceed to (i) a point/object dialog for an engine 1404 (e.g., the item information GUI 1000 including the diagnostics tab 1010, the focus tab 1020, the commands tab 1030, and the recent activity tab 1040 for the selected engine, etc.) in response to selecting a respective engine name on the space dashboard 1402, (ii) a point/object dialog for an a trunk 1406 (e.g., the item information GUI 1000 including the diagnostics tab 1010, the focus tab 1020, the commands tab 1030, and the recent activity tab 1040 for the selected trunk, etc.) in response to selecting a respective trunk name on the space dashboard 1402, (iii) a point/object dialog for a point 1408 (e.g., the item information GUI 1000 including the diagnostics tab 1010, the focus tab 1020, the commands tab 1030, the recent activity tab 1040, and the command priorities tab 1050 for the selected point, etc.) in response to selecting a respective point name on the space dashboard 1402, and/or (iv) at least one of (a) a point/object dialog for a field controller 1410 (e.g., the item information GUI 1000 including the diagnostics tab 1010, the focus tab 1020, the commands tab 1030, and the recent activity tab 1040 for the selected field controller, etc.) and (b) a live logic view 1412 (e.g., the live logic GUI 1100, etc.) in response to selecting a respective field controller name on the space dashboard 1402. The user may proceed from the live logic view 1412 to the point/object dialog for a point 1408 in response to selecting a respective point name on the live logic view 1412.

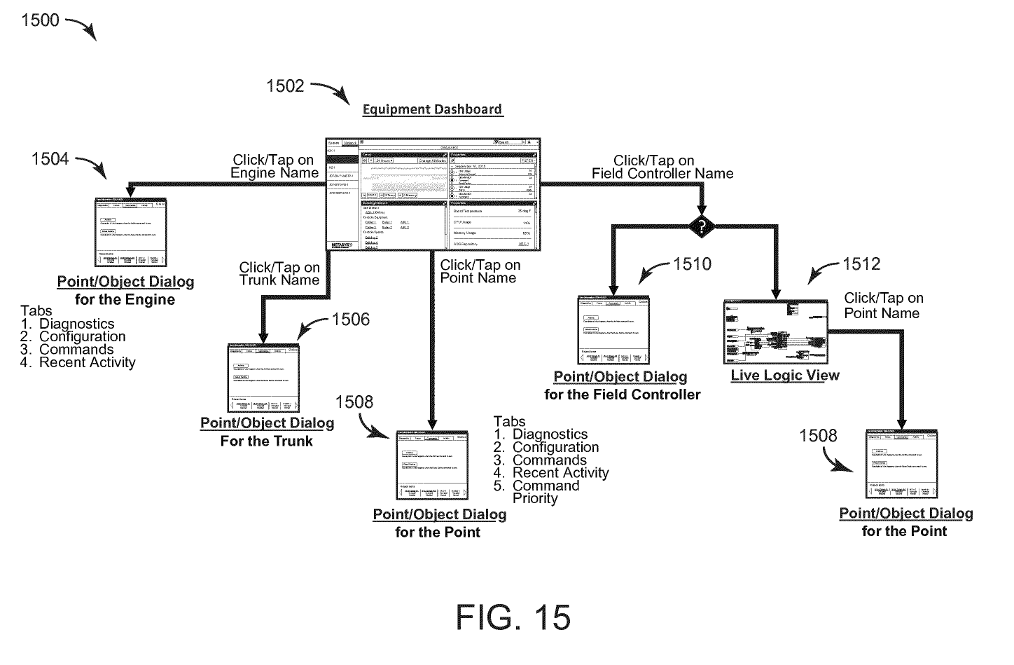

As shown in FIG. 15, a user may start from an equipment dashboard 1502 (e.g., the equipment summary GUI 800, the building navigation GUI 900, etc.). The user may then proceed to (i) a point/object dialog for an engine 1504 (e.g., the item information GUI 1000 including the diagnostics tab 1010, the focus tab 1020, the commands tab 1030, and the recent activity tab 1040 for the selected engine, etc.) in response to selecting a respective engine name on the equipment dashboard 1502, (ii) a point/object dialog for an a trunk 1506 (e.g., the item information GUI 1000 including the diagnostics tab 1010, the focus tab 1020, the commands tab 1030, and the recent activity tab 1040 for the selected trunk, etc.) in response to selecting a respective trunk name on the equipment dashboard 1502, (iii) a point/object dialog for a point 1508 (e.g., the item information GUI 1000 including the diagnostics tab 1010, the focus tab 1020, the commands tab 1030, the recent activity tab 1040, and the command priorities tab 1050 for the selected point, etc.) in response to selecting a respective point name on the equipment dashboard 1502, and/or (iv) at least one of (a) a point/object dialog for a field controller 1510 (e.g., the item information GUI 1000 including the diagnostics tab 1010, the focus tab 1020, the commands tab 1030, and the recent activity tab 1040 for the selected field controller, etc.) and (b) a live logic view 1512 (e.g., the live logic GUI 1100, etc.) in response to selecting a respective field controller name on the equipment dashboard 1502. The user may proceed from the live logic view 1512 to the point/object dialog for a point 1508 in response to selecting a respective point name on the live logic view 1512.

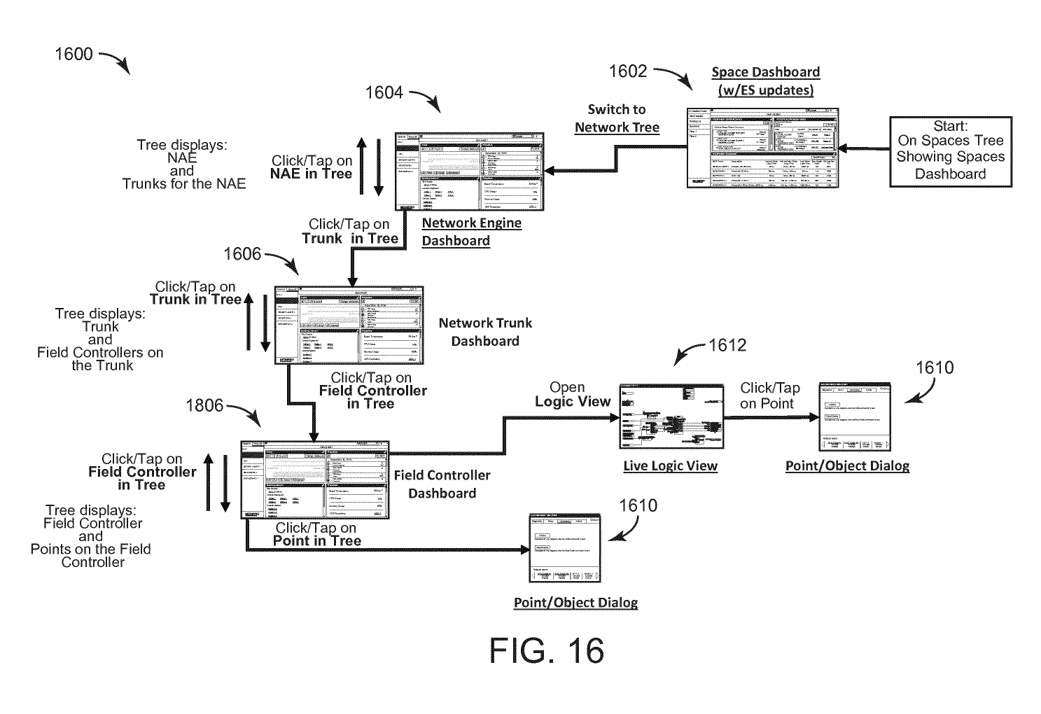

As shown in FIG. 16, a user may start from a space dashboard 1602 (e.g., the equipment summary GUI 800, etc.). The user may then switch to a network tree (e.g., the network navigation tree 916, etc.) and proceed to a network engine dashboard 1604. The user may then proceed to a network trunk dashboard 1606 in response to selecting trunk in the network tree. The user may then proceed to a field controller dashboard 1608 in response to selecting field controller in the network tree. The user may then proceed to a point/object dialog for a point 1610 in response to selecting a point in the network tree. controller dashboard 1608 in response to selecting field controller in the network tree. From the field controller dashboard 1608, the user may open a live logic view (e.g., the live logic GUI 1100, etc.). The user may proceed from the live logic view 1612 to the point/object dialog for a point 1508 in response to selecting a respective point name on the live logic view 1612.

### Configuration of Example Embodiments

The construction and arrangement of the systems and methods as shown in the various example embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the example embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

1. A building management system (BMS), comprising:
a processing circuit coupled to a building network, the building network including at least one server, at least one supervisory engine, at least one field controller, and at least one edge device, the processing circuit configured to:
provide a graphical user interface including a building network riser diagram of the building network having at least two of (i) a server section configured to display a first graphical representation of the at least one server, (ii) an engine section configured to display a second graphical representation of the at least one supervisory engine, (iii) a field controller section configured to display a third graphical representation of the at least one field controller, and (iv) an edge device section configured to display a fourth graphical representation of the at least one edge device.

2. The BMS of claim 1, wherein at least one of the first graphical representation, the second graphical representation, the third graphical representation, and the fourth graphical representation displayed within the building network riser diagram includes an actual image of the at least one server, the at least one supervisory engine, the at least one field controller, and the at least one edge device, respectively.

3. The BMS of claim 1, wherein at least one of the first graphical representation, the second graphical representation, the third graphical representation, and the fourth graphical representation displayed within the building network riser diagram includes a selectable link.

4. The BMS of claim 3, wherein the processing circuit is further configured to provide a second graphical user interface including at least one of diagnostics information, properties, commands, and recent activity in response to a selection of the selectable link for at least one of (i) one of the at least one server, (ii) one of the at least one supervisory engine, and (iii) one of the at least one field controller, and (iv) one of the at least one edge device associated with the selectable link.

5. The BMS of claim 1, wherein the processing circuit is further configured to filter the building network riser diagram based on a selection of at least one of (i) a server within the server section, (ii) a supervisory engine within the engine section, (iii) a field controller within the field controller section, and (iv) an edge device within the edge device section.

6. The BMS of claim 5, wherein the processing circuit is configured to filter out all servers except for an ancestor server of a selected field controller, all supervisory engines except for a parent supervisory engine of the selected field controller, all other field controllers except for the selected field controller, and all edge devices except for children edge devices of the selected field controller.

7. The BMS of claim 5, wherein the processing circuit is configured to filter out all servers except for an ancestor server of a selected supervisory engine, all other supervisory engines except for the selected supervisory engine, all field controllers except for children field controllers of the selected supervisory engine, and all edge devices except for children edge devices of the selected supervisory engine.

8. The BMS of claim 5, wherein the processing circuit is configured to filter out all other servers except for a selected server, all supervisory engines except for children supervisory engines of the selected server, all field controllers except for children field controllers of the selected server, and all edge devices except for children edge device of the selected server.

9. The BMS of claim 5, wherein the processing circuit is configured to filter out all servers except for ancestor servers of a selected edge device, all supervisory engines except for parent supervisory engines of the selected edge device, all field controllers except for parent field controllers of the selected edge device, and all other edge devices except for the selected edge device.

10. The BMS of claim 1, wherein the building network further includes at least one point, and wherein the building network riser diagram of the building network has a point section configured to display a fifth graphical representation of the at least one point.

11. A building management system (BMS), comprising:
a processing circuit coupled to a building network, the building network having a plurality of points, the processing circuit configured to provide a graphical user interface including:
current priorities for a selected point of the plurality of points;
potential impacts for the selected point of the plurality of points; and
a priority array that orders the current priorities from a highest priority level to a lowest priority level.

12. The BMS of claim 11, wherein the processing circuit is further configured to provide a description of each priority level of the priority array within the graphical user interface.

13. The BMS of claim 11, wherein the graphical user interface includes at least one of:
a release all priorities button configured to facilitate releasing all of the current priorities affecting the selected point; and
a release a single priority button configured to facilitate releasing a single priority of the current priorities affecting the selected point.

14. The BMS of claim 11, wherein the current priorities include commands at least one of (i) received by the processing circuit from an operator of the BMS and (ii) generated by the processing circuit.

15. The BMS of claim 14, wherein the processing circuit is configured to determine a priority level of a command received from the operator based on a permission level of the operator.

16. The BMS of claim 14, wherein the processing circuit is configured display at least one of when and by whom a command was issued or removed.

17. The BMS of claim 11, wherein the graphical user interface further includes at least one of (i) trend information and (ii) alarm and audit information regarding the selected point of the plurality of points.

18. A building management system (BMS), comprising:
a processing circuit coupled to a building network, the building network having a plurality of points, the processing circuit configured to provide a graphical user interface including:
at least one of trend information and audit information regarding a selected point of the plurality of points;
current priorities for the selected point of the plurality of points; and
potential impacts for the selected point of the plurality of points.

19. The BMS of claim 18, wherein the graphical user interface includes a priority array that orders the current priorities from a highest priority level to a lowest priority level.

20. The BMS of claim 18, wherein the audit information includes alarm and command audit trails associated with the selected point.
